(19) United States
(12) Patent Application Publication
(10) Pub. No.: US 2006/0210437 A1
(43) Pub. Date: Sep. 21, 2006

(54) Sugar chain analyzing apparatus

(75) Inventor: Yusuke Osaka, Kyoto-shi (JP)

Correspondence Address: RANKIN, HILL, PORTER & CLARK LLP, 4080 ERIE STREET, WILLOUGHBY, OH, 44094-7836, US

(73) Assignee: SHIMADZU CORPORATION, Kyoto-shi (JP)

(21) Appl. No.: 11/371,734

(22) Filed: Mar. 9, 2006

(30) Foreign Application Priority Data
Mar. 17, 2005 (JP) 2005-076407

(51) Int. Cl. G01N 30/00

(52) U.S. Cl. 422/70

(57) ABSTRACT

Different lectins are immobilized in four columns, respectively. A sample containing a sugar chain is injected from a sample injection section, sent to one of the columns through a first flow path switching valve and a second or third flow path switching valve. Then, an eluate of the column is sent to a detector through a fourth flow path switching valve and is detected. Simultaneously, a cleaning solution is sent to one of columns, which differs from the column performing the analysis, through the first flow path switching valve and the second or third flow path switching valve. After the column is cleaned, the cleaning solution is discharged to a drain through the fourth flow path switching valve. Measurements are performed in the four columns sequentially, and measurement data are inputted into an arithmetic control device. Subsequently, data representing interactions between the sugar chain and the lectins are obtained.

This application claims foreign priority based on Japanese Patent application No. 2005-076407, filed Mar. 17, 2005, the content of which is incorporated herein by reference in its entirety.

### BACKGROUND OF THE INVENTION

1. Field of the Invention

The present invention relates to a sugar chain analyzing apparatus using a liquid chromatograph, and more particularly, to an apparatus for obtaining magnitude of interaction between a sugar chain and a lectin by screening, and estimating a structure and characteristics of the sugar chain or the lectin.

2. Description of the Related Art

Like terms “genome” and “proteome”, which are respectively defined as concepts indicating entirety of genes and that of proteins, an entirety of sugar chains as a third class of biosis chains is referred to as “glycome”. An existence form, function, and structure of the sugar chains have been studied.

Lectin is a protein that recognizes and binds a specific sugar chain structure. It is known that the lectin recognizes not only the kind of a monosaccharide but also the sugar chain structure including anomer (or tautomer) configuration and a binding position of the sugar. Activity of the lectin is various, and also the structure of the lectin is various. Refinement of complex sugar chains and separation/fractionation of cell groups by a lectin column using the above properties are studied variously (for example, refer to JP-A-5-223806).

FIG. 2 is a diagram illustrating flow paths in a related sugar chain analyzing apparatus using the lectin column.

Two columns 9 and 10 are attached between flow path switching valves 6 and 7 in order to measure the magnitude of the interaction between the sugar chain and the lectin. Then, the lectin, which may interact with the sugar chain contained in a sample, is immobilized in each of the columns 9 and 10. Subsequently, the sugar chain on which screening is to be performed is injected from a sample injection section 5. Then, a mobile phase 1 is delivered by liquid transfer pumps 3 and 4, and analysis is performed by using a detector 8.

In this apparatus, by the switching between the flow path switching valves 6 and 7, while the analysis is performed with one of the columns 9, cleaning of the other column 10 is performed. Thus, the efficiency in performing experimental operations is enhanced. Consequently, data can be obtained from the two columns by performing the analysis once.

Then, the columns 9 and 10 are replaced with columns each of which contains a lectin differing from the lectin contained in the columns 9 and 10, and the above operation is performed a plurality of times. A user activates software for calculation with the obtained data, and obtains data concerning the interaction between the sugar chain and the lectin, for example, a binding constant (for example, refer to JP-A-6-249841). Consequently, the characteristics and the structure of an unknown sugar chain can be estimated.

In the related apparatus, the number of columns which can be set therein is two. Thus, the binding constants of the sugar chain and only the two different lectins can be obtained. In order to estimate or classify the structure of the unknown sugar chain, it is necessary to perform the column replacement by attaching and detaching for a plurality of times. Such replacing operations are troublesome.

Furthermore, measurement data which are necessary for the structure analysis of the sugar chain or the like cannot be obtained by performing the measurement once. Therefore, automation of processes from obtaining the measurement data to processing the data is not easy.

### SUMMARY OF THE INVENTION

An object of the invention is to provide a sugar chain analyzing apparatus for automatically obtaining data relating to an interaction between a sugar chain and a lectin based on obtained chromatogram data, by setting a number of columns mountable in the apparatus at an optimal number which is larger than the number of columns mountable in the related apparatus.

In some implementations, a sugar chain analyzing apparatus of the invention using a liquid chromatograph comprises: a sample injection section for injecting a sample, a solution containing a sugar chain being used as the sample; at least four columns in which different lectins are respectively immobilized; a flow path connection forming a flow path for analysis in which a mobile phase is supplied through the sample injection section to one of said at least four columns so as to deliver the sample to the column and in which the mobile phase is sent to a detector, and simultaneously forming a flow path for cleaning in which a cleaning solution is fed to another one of said at least four columns; a flow path switching mechanism for switching the flow path connection in said at least four columns; and an arithmetic control device having a program for obtaining data relating to interactions between the sugar chain and the lectins based on detection data from the detector, the detection data being acquired by using eluates from said at least four columns.

In some implementations, in the sugar chain analyzing apparatus of the invention, lectins may be immobilized in the columns, and a sugar chain mat be injected as the sample. In this case, the data relating to the interactions between the sugar chain and the lectins can automatically be obtained based on the detection data from the detector, the detection data being acquired by using eluates from the at least four columns, similarly as described above.

In the sugar chain analyzing apparatus of the invention, the same solvent may be used as both of the mobile phase and the cleaning solution.

According to the sugar chain analyzing apparatus of the invention, since at least four columns are provided at the same time, replacement of the columns by attaching and detaching is not required. Moreover, the data relating to interactions between the sugar chain and the four or more kinds of lectins can be obtained at one experimental operation. Consequently, the operability of the apparatus can be improved. Furthermore, an operation can be automated by inputting such measurement data into the arithmetic control device.

For example, in a case where a sugar specificity of the lectin is preliminarily obtained, it can roughly be estimated what kind of the sugar chain an identified glycoprotein has. Consequently, the classification of a core member (that is, the estimation of a structural characteristic) can be achieved by performing the analysis once. For example, the classification and the identification of the core member can be performed, such as in a case of an N-type sugar chain, it can be determined whether the core member thereof is the high mannose type or the complex type.

In a case where at least four columns, in which different sugar chains are respectively immobilized, are used, and where the sample containing the lectin is injected, the affinity of the lectin for each of the sugar chains can be obtained.

When the same solvent is used as both of the mobile phase and the cleaning solution, which are respectively used as the sample liquid and the cleaning liquid, the configuration of the apparatus can be simplified by reducing the number of the flow paths.

Also, in the sugar chain analyzing apparatus of the invention, the arithmetic control device for obtaining the data relating to the interaction between the sugar chain and the lectin is provided. Thus, the process from the analysis to the calculation of the data relating to the interaction can automatically be performed. Consequently, only a start of the initial analysis is manually operated, and the subsequent processes up to the calculation of the data relating to the interaction can automatically be performed.

### BRIEF DESCRIPTION OF THE DRAWINGS

FIGS. 1A to 1D are diagrams each illustrating flow paths in a sugar chain analyzing apparatus according to an embodiment of the invention, and illustrating flow path connections when flow path switching valves are switched.

FIG. 2 is a diagram illustrating flow paths in a related sugar chain analyzing apparatus.

### DESCRIPTION OF THE PREFERRED EMBODIMENTS

Hereinafter, an embodiment of the invention is described by referring to the accompanying drawings.

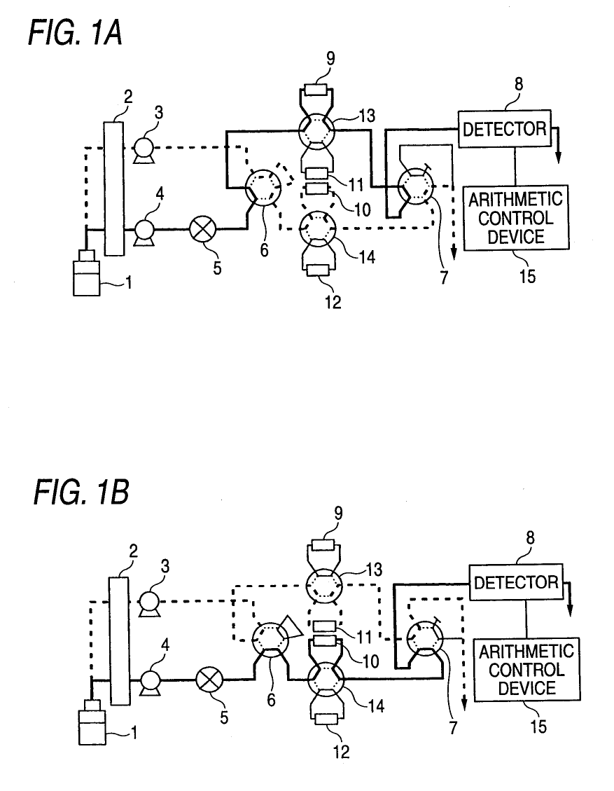

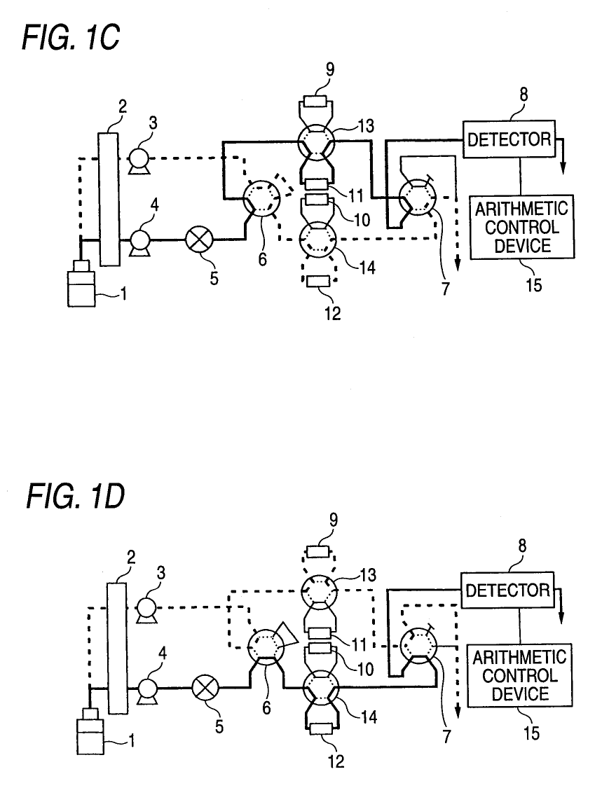

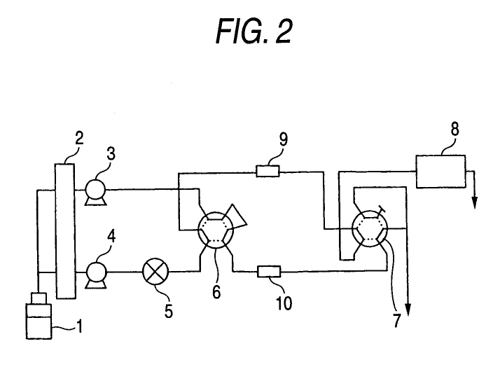

FIGS. 1A to 1D are diagrams each illustrating flow paths in a sugar chain analyzing apparatus according to an embodiment of the invention, and show differences in the flow paths when flow path switching valves are switched. Thick solid lines indicate the flow path of a mobile phase for analysis. Thick dashed lines indicate the flow path of a cleaning solution.

Two flow path switching valves 13 and 14 are further connected between two flow path switching valves 6 and 7 so that the flow path valve 13 or 14 can be selected by switching the flow path valves 6 and 7. Two columns are connected to each of the flow path switching valves 13 and 14, so that one of the columns 9 and 11 is selected by the flow path switching valve 13, and one of the columns 10 and 12 is selected by the flow path switching valve 14.

A flow path which supplies a solvent in a container 1 as the mobile phase for analysis by a liquid transfer pump 3, and a flow path which supplies the solvent in the container 1 as the cleaning solution by a liquid transfer pump 4 are connected to the flow path switching valve 6. In the flow paths through which the solvent in the container 1 is transferred, a deaerator 2 for removing gas bubbles in the solvent is provided. The flow paths are switched by switching the flow path switching valve 6 so that the mobile phase for analysis and the cleaning solution are supplied to the flow path switching valves 13 and 14.

In this embodiment, the solvent in the container 1 is used as both of the mobile phase for analysis and the cleaning solution. However, different solvents may be respectively used as the mobile phase for analysis and the cleaning solution, and also may be respectively supplied through different flow paths.

The flow path switching valve 7 is connected with a flow path connecting to a detector 8, and a flow path for drain.

By switching the flow path switching valve 7, a column eluate obtained from the flow path switching valve 13 or 14 is sent to the detector 8, and the cleaning solution obtained from the flow path switching valve 13 or 14 is discharged to the drain.

Different lectins are immobilized in the columns 9, 10, 11, and 12, respectively. It is necessary to select the lectins each of which sugar specificity is preliminarily known. Generally, examples of such lectins are Concanavalin A (Con A) having a high affinity for a high mannose type N-linked sugar chain, Ricinus communis agglutinin I (RCA-I) lectin having an affinity for a β-galactoside-containing sugar chain, and peanut lectin (PNA) having a selectivity for core 1 structure (T-antigen), which is a basic structure of an O-linked sugar chain.

The detector 8 is connected to an arithmetic control device 15, and detection data is inputted to the arithmetic control device 15. The arithmetic control device 15 has a program for a data input by a user, a storing of the detection results, a search of stored data of the sugar chain, a calculation of data relating to the interactions, a display of results, and so on. Also, the arithmetic control device 15 controls an operation of the sugar chain analyzing apparatus entirely. Data relating to the structures, the characteristics or the like which are derived from the binding relation between the sugar chains and the lectins are stored in a storage portion of the arithmetic control device 15. Thus, sugar chains as described in “Oligosaccharide specificity of galectins: a search by frontal affinity chromatography”, J. Hirabayashi, et al., Biochimica et Biophysica Acta, 1572, (2002), 232-254, can be analyzed.

Next, operations of the sugar chain analyzing apparatus according to the embodiment are described below by sequentially referring to FIGS. 1A to 1D.

For example, a refined bodily secretion is used as the sample containing the sugar chain, and the binding constant of the sugar chain and the lectin is obtained.

FIG. 1A shows a flow path connection indicating an operation of performing the analysis in the column 9 and cleaning the column 10 simultaneously.

The sample containing the sugar chain to be analyzed is sent from a sample injection section 5 to the column 9 through the flow path switching valves 6 and 13, the sample being sent by the mobile phase that is delivered by the pump 4. Thereafter, the eluate obtained from the column 9 is sent to the detector 8 by the flow path switching valve 7, and is detected by the detector 8. The arithmetic control device 15 acquires the chromatogram data obtained by the detector 8, and obtains the interaction data between the sugar chain and the lectin immobilized in the column 9 by calculation.

Simultaneously with the analysis, the cleaning solution delivered by the pump 3 is sent to the column 10 through the flow path switching valves 6 and 14. Then, the column 10 is cleaned, and the cleaning solution is discharged to the drain through the flow path switching valve 7.

FIG. 1B shows a flow path connection indicating an operation of performing the analysis in the column 10 and cleaning the column 11 simultaneously.

The sample is sent from the sample injection section 5 to the column 10 through the flow path switching valves 6 and 14, the sample being sent by the mobile phase that is delivered by the pump 4. Thereafter, the eluate obtained from the column 10 is sent to the detector 8 by the flow path switching valve 7, and is detected by the detector 8. The arithmetic control device 15 acquires the chromatogram data obtained by the detector 8, and obtains the interaction data between the sugar chain and the lectin immobilized in the column 10 by calculation.

Simultaneously with the analysis, the cleaning solution delivered by the pump 3 is sent to the column 11 through the flow path switching valves 6 and 13. Then, the column 11 is cleaned, and the cleaning solution is discharged to the drain through the flow path switching valve 7.

FIG. 1C shows a flow path connection indicating an operation of performing the analysis in the column 11 and cleaning the column 12 simultaneously.

The sample is sent from the sample injection section 5 to the column 11 through the flow path switching valves 6 and 13, the sample being sent by the mobile phase that is delivered by the pump 4. Thereafter, the eluate obtained from the column 11 is sent to the detector 8 by the flow path switching valve 7, and is detected by the detector 8. The arithmetic control device 15 acquires the chromatogram data obtained by the detector 8, and obtains the interaction data between the sugar chain and the lectin immobilized in the column 11 by calculation.

Simultaneously with the analysis, the cleaning solution delivered by the pump 3 is sent to the column 12 through the flow path switching valves 6 and 14. Then, the column 12 is cleaned, and the cleaning solution is discharged to the drain through the flow path switching valve 7.

FIG. 1D shows a flow path connection indicating an operation of performing the analysis in the column 12 and cleaning the column 9 simultaneously.

The sample is sent from the sample injection section 5 to the column 12 through the flow path switching valves 6 and 14, the sample being sent by the mobile phase that is delivered by the pump 4. Thereafter, the eluate obtained from the column 12 is sent to the detector 8 by the flow path switching valve 7, and is detected by the detector 8. The arithmetic control device 15 acquires the chromatogram data obtained by the detector 8, and obtains the interaction data between the sugar chain and the lectin immobilized in the column 12 by calculation.

Simultaneously with the analysis, the cleaning solution delivered by the pump 3 is sent to the column 9 through the flow path switching valves 6 and 13. Then, the column 9 is cleaned, and the cleaning solution is discharged to the drain through the flow path switching valve 7.

The arithmetic control device 15 comprehensively determines the data relating to the interactions between the sugar chain and the lectins, and the like, based on the binding constants respectively obtained in the processes illustrated in FIGS. 1A to 1D. Consequently, the binding constants of the sugar chain as the measurement object and each of the four different lectins are obtained, and the characteristic and the structure of the sugar chain can be estimated, at one experimental operation.

The sugar chain analyzing apparatus according to the invention is not limited to the aforementioned embodiment. Different sugar chains may be immobilized in the columns respectively, and the lectin may be injected as the sample. In this case, the affinity of lectin for the sugar chain can be obtained by screening.

According to the sugar chain analyzing apparatus of the invention using a liquid chromatograph, the magnitude of the interaction between the sugar chain and the lectin can be obtained by screening, and the structure and the characteristics of the sugar chain or the lectin can be estimated.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A sugar chain analyzing apparatus using a liquid chromatograph, the sugar chain analyzing apparatus comprising:
a sample injection section for injecting a sample, a solution containing a sugar chain being used as the sample;
at least four columns in which different lectins are respectively immobilized;
a flow path connection forming a flow path for analysis in which a mobile phase is supplied through the sample injection section to one of said at least four columns so as to deliver the sample to the column and in which the mobile phase is sent to a detector, and simultaneously forming a flow path for cleaning in which a cleaning solution is fed to another one of said at least four columns;
a flow path switching mechanism for switching the flow path connection in said at least four columns; and
an arithmetic control device having a program for obtaining data relating to interactions between the sugar chain and the lectins based on detection data from the detector, the detection data being acquired by using eluates from said at least four columns.

2. A sugar chain analyzing apparatus using a liquid chromatograph, the sugar chain analyzing apparatus comprising:
a sample injection section for injecting a sample, a solution containing a lectin being used as the sample;
at least four columns in which different sugar chains are respectively immobilized;
a flow path connection forming a flow path for analysis in which a mobile phase is supplied through the sample injection section to one of said at least four columns so as to deliver the sample to the column and in which the mobile phase is sent to a detector, and simultaneously forming a flow path for cleaning in which a cleaning solution is fed to another one of said at least four columns;
a flow path switching mechanism for switching the flow path connection in said at least four columns; and
an arithmetic control device having a program for obtaining data relating to interactions between the sugar chains and the lectin based on detection data from the detector, the detection data being acquired by using eluates from said at least four columns.

3. The sugar chain analyzing apparatus according to claim 1, wherein a same solvent is used as both of the mobile phase and the cleaning solution.

4. The sugar chain analyzing apparatus according to claim 2, wherein a same solvent is used as both of the mobile phase and the cleaning solution.
